(19) United States
(12) Patent Application Publication
(10) Pub. No.: US 2010/0228589 A1
(43) Pub. Date: Sep. 9, 2010

(54) Behavior-based feedback and routing in social-networking business

(75) Inventor: Wei Kang Tsai, Irvine, CA (US)

Correspondence Address: Wei Kang Tsai, 8 Young Court, Irvine, CA, 92617, US

(73) Assignee: Grasstell Networks LLC

(21) Appl. No.: 12/381,045

(22) Filed: Mar. 5, 2009

(51) Int. Cl. G06Q 30/00; G06Q 99/00; G06Q 10/00; G06Q 50/00

(52) U.S. Cl. 705/10; 705/26; 705/7; 705/319; 705/14.25

(57) ABSTRACT

A system and method to incentivize members in social networking businesses model is based on historic and time-dependent behavior of members. Bilateral feedback mechanisms are used to influence behaviors of individual members and partners by rewarding benefiting behaviors and penalizing anti-benefiting behaviors explicitly. Rules for selecting matching supplying and demanding sites are also influenced by the historic behaviors of the supplying and demanding members or partners. Paths to route goods and services in a social-networking community are also chosen to increase competitive pricings and the selection of product offerings, based on current and historic behaviors of members and partners.

### CROSS REFERENCE TO RELATED APPLICATION

This application claims the benefit of U.S. Provisional Patent Application Ser. No. 61/066,616, filed Feb. 21, 2008, the disclosure of which is herein expressly incorporated by reference.

### FIELD OF THE INVENTION

The present invention relates in general, to structure and routing in social-networking business models and more particularly, to behavior-based feedbacks and behavior-based routing in social-networking business models.

### BACKGROUND OF THE INVENTION

Social networking is an emerging business model that has helped build famous companies such as Wikipedia, Skype, YouTube, Facebook, etc. The basic concept is based on sharing by people of common interests, and more generally, social behaviors of the common people, which might be called the grassroots.

A major portion of social networking businesses focuses on online social networks for communities of people who share interests and activities. These businesses are often referred to as Web 2.0 companies.

Closely related to the Web 2.0 model is the mass collaboration business model, which is based on four principles: openness, peering, sharing, and acting globally. A key difference from old business models is that mass collaboration relies on free-willed individuals working jointly to solve a problem. This kind of outsourcing is also referred to as crowd-sourcing. Both Web 2.0 and mass collaboration models are part of general social-networking models.

Social networking businesses can also be thought of as being driven by P2P (peer to peer) technology. The central principle of P2P technology is that a participating agent is both a server and client. This concept can be generalized so that a participating agent is a three-in-one: server, client, and owner. This matches the famous declaration by late President Lincoln: “Of the People, by the People, for the People.”

Adding ownership concept to the Web 2.0 model is significant enough that some have considered this to extend Web 2.0 model to the next generation, which is known as Web 3.0. However, it must be mentioned that there are no universal agreements on the meaning of Web 3.0.

As a business, a social-networking business aims to maximize its return on investment. A central issue is to incentivize members of the community so that the individual (selfish) objectives, social (community) objectives, and corporate objectives coincide.

While there exist many incentive systems for social-networking models, bilateral (both positive and negative) feedback mechanisms are rarely deployed. The present invention is differentiated by executing bilateral feedback mechanisms.

In most social-networking models, beneficial (“good”) behaviors are rewarded while anti-beneficial (“bad”) behaviors are penalized. Key differentiators of the present invention are comprised of behavior-based bilateral incentive feedbacks and behavior-based routing.

Most behavior measures do not take into account of time: history and time-varying aspects of member behaviors. The present invention provides incentive systems with explicit consideration of time aspects.

A key aspect of social-networking businesses is members sharing or selling their own resources within or without a community. To facilitate sharing and commerce, a matching process must determine what shared or sold resources or supplies are to be routed to what demands. This is the routing problem in social networking; this routing must be differentiated from physical routing in physical networks.

Further, routing in social networks may involve multiple hops. For example, a social network based VoIP service may route a VoIP call through multiple nodes to minimize latency or to maximize performance metrics. In this way, the routing problem in social-network businesses is more than supply-demand matching; it is indeed a problem of selecting physical paths connecting a source to destinations within a selected group of nodes.

Current routing solutions for social-networking businesses do not take into account of peer's (member's) behavior explicitly. Explicit consideration of member behaviors is a key differentiator for the present invention.

### BRIEF SUMMARY OF THE INVENTION

It is, therefore, an object of the present invention to construct incentive systems that incorporate bilateral feedbacks to induce beneficial behaviors and to reduce anti-beneficial behaviors, thus maximizing the return on investment.

It is yet another object of the present invention to construct a community policy wherein ownership of intellectual properties is protected.

It is yet another objective of the present invention to construct behavior-based social routing in the infrastructure of a social-networking community.

In accordance with one aspect of the present invention, there is provided a method to measure the quality of a resource or supply, based on time-dependent and historic behaviors of the providing members or partners.

In accordance with one aspect of the present invention, there is provided a method to rank the quality of a resource or supply based on time-dependent and historic behaviors of the providing members or partners.

In accordance with one aspect of the present invention, there is provided a method to allow a member or partner to receive behavioral credits based on time-dependent and historic behaviors of the member or partner.

In accordance with one aspect of the present invention, there is provided a method to allow a member of a community to obtain preferential treatments in the activities in the community based on behavioral credits received from within the community.

In accordance with one aspect of the present invention, there is provided a method to select a routing path based on the behaviors of the individual nodes in the infrastructure of a community.

### BRIEF DESCRIPTION OF THE DRAWINGS

The above and other objects and features in accordance with the present invention will become apparent from the following descriptions of embodiments in conjunction with the accompanying drawings, and in which:

FIG. 1 depicts the relationship between members, partners, a community and its sponsoring corporation;

FIG. 2 shows behavior-based bilateral feedback with time-dependence.

### DETAILED DESCRIPTION OF EXEMPLARY EMBODIMENTS

The present invention can be logically divided into two inter-related parts: behavior-based bilateral feedback, and behavior-based routing.

To facilitate the disclosure, a member is considered to be a logical entity, and a collective body of members is referred to as a community. A community can be self-owned by its members, or owned jointly by its members and a sponsoring corporation. A logical entity in a partnership with a community is referred to as a partner; otherwise, any logical entity which is neither a member nor a partner is referred to as a non-member. A logical entity can be an individual, an organization, a community, a business, or a group of connected people.

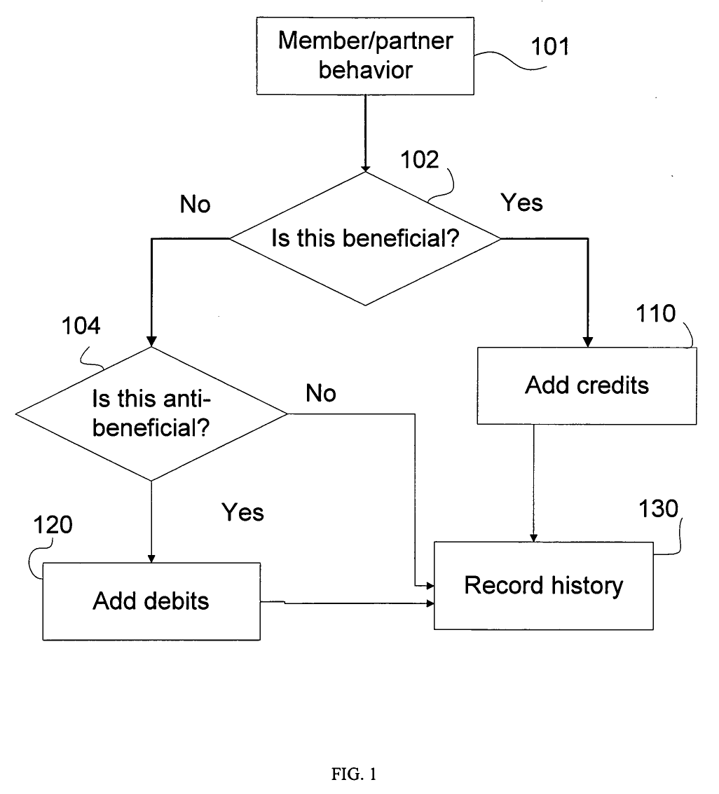

In FIG. 1, a community (100) is formed by its members (101) and its sponsoring corporation (102); while partners (102) who are not part of the community have a partnership with the community.

In an embodiment, a positive feedback mechanism is enacted by rewarding “good” behaviors of members and partners of a community. In this embodiment, good behaviors include but are not restricted to:
(1) Consistently providing high-quality resources (communication bandwidth, computing resources, storage resources, or other goods and services) to and for the community either for free or for fees;
(2) Providing content to and for the community either for free or for fees;
(3) Putting a network routing device in front of a NAT (network address translation) box between the public Internet and a private IP network for the community.

In another embodiment, a negative feedback mechanism is enacted by penalizing “bad” behaviors of members and partners of a community. In this embodiment, bad behaviors include but are not restricted to:
(1) Violating the privacy of members and non-members by eavesdropping on conversations carried out by members or partners;
(2) Malicious attacks on the infrastructure of the community or individual members;
(3) Violating an intellectual property policy of the community;
(4) Inconsistently providing resources to or for the community.

In yet another embodiment of the present invention, bilateral feedback mechanisms are embodied in the form of behavioral credits and debits. Good behaviors from a member or partner of a community will entitle the member or partner with behavioral credits in his account; while bad behaviors from a member or partner will result in the removal of behavioral credits or adding of behavioral debits in the member's or partner's account. The amounts of behavioral credits and debits are proportional to a measure of “goodness” and “badness” in the behaviors of individual members and partners.

In an embodiment of the present invention, a measure of individual member's or partner's behavior in a community is a function of (1) historical behaviors, (2) the current behaviors, and (3) time-dependent factors such as holidays, vacations, special events, and promotion activities.

In yet another embodiment, a behavior measure is computed as a single number as follows: b(t+1)=b(t)*(1−df)+df*B(t); wherein b(t) is a long-time behavior measure at time t, df is a discount factor (df satisfies the condition, 0<df<1), and B(t) is the instantaneous behavior measure at time t. This formula is the classic exponential moving average formula used in numerous time-series applications.

In an embodiment of the present invention, positive behavioral credits in an individual member's or partner's account in a community can be used to obtain preferential treatments in the activities associated with the community. Positive behavioral credits may also be exchanged with goods and services or actual money provided by the community or the sponsoring corporation, according to specific exchange rules.

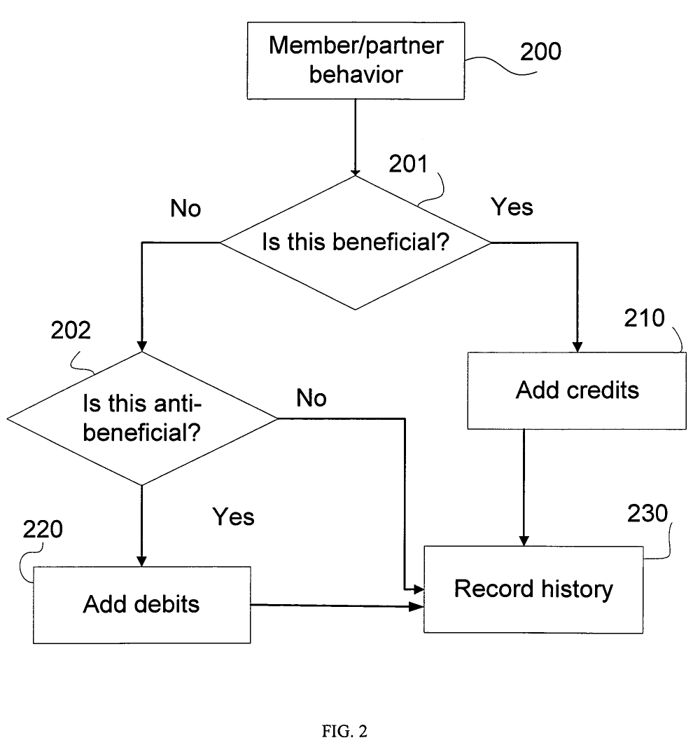

In FIG. 2 an embodiment of a bilateral feedback is depicted. For a member or partner, a particular behavior (200) is first examined (201) for its benefits to the community. If the behavior is deemed beneficial, then credits will be added to account of the member or partner (210); otherwise, the behavior is examined (201) for its anti-benefits. If the behavior is deemed anti-beneficial, then debits will be added to the account of the member or partner (220). After all these have been done, the behavior is recorded and summarized in other behavior measures. (230).

Contributions from a member or partner to a community include but are not restricted to: allowing the community to use the resource owned by the member or partner, generating content and allowing the community to distribute the content, and providing other forms of goods or services.

In return, a community may also provide goods or services to individual members or partners through businesses owned by the community, or business owned by individual members or partners, or business jointly owned by a combination of the community, individual members, non-members, and partners.

In an embodiment of the present invention, a piece of intellectual property created by a member with the help of a community's infrastructure (hardware, software, and community efforts are all counted) is subject to a fair-use policy of the community. A fair-use policy implies that, to the extent the intellectual property utilizes the community infrastructure, the community has a proportional right to use it for free. A fair-use policy may contain a combination of the following rules:
(1) All intellectual properties thus created belong to the community in part or in whole;
(2) All intellectual properties thus created belong to the individual creators in part or in whole;
(3) The community owns distribution rights of the content thus created in part or in whole.

In an embodiment of the present invention, supply and demand for goods and services are matched based on behavioral credit ratings of the supplying and demanding parties, if either or both parties are members or partners. The specific rules for routing supplies and demands include but are not restricted to:
(1) The higher the behavioral credit ratings of demanding parties, the higher will be the quality of supplies routed to the demanding parties;
(2) While everything else being equal, for a given demand, multiple independent supply sources are to be used;
(3) While everything else being equal, for the same behavioral credit ratings, members and partners should be given an equal opportunity to be used as supply sources;
(4) While everything else being equal, members and partners with zero or low behavioral credit ratings should be given sufficient chances to function as supply sources, to enable their ratings to be improved.

In an embodiment of the present invention, paths from sources to destinations in a community to route commodities (goods or service) are selected based a combination of the following metrics:
(1) The merit of a path is the sum of net behavioral credits minus debits of the nodes in the path;
(2) The merit of a path is the maximum of the net behavioral credits minus debits of the nodes in the paths;
(3) The merit of a path is a non-decreasing function of the net behavioral credits minus debits of the nodes in the paths.

In an embodiment of the present invention, to route commodities (goods or services) from a source to a destination in a community, a plurality of paths is selected.

As the above description tends to be general and abstract, it is instructive to provide embodiments relating to real-world applications.

In one embodiment, a member is one that buys or leases a piece of CPE (customer premise equipment) such as an IAD (integrated access device), a video phone, a wireless router, or a desktop computer. A community is formed by these members with a sponsoring corporation that sells or leases out the CPE. The community members share the broadband bandwidths and computing resources owned by the individual members. A partner is a business that provides third-party software that can be inserted into the CPE. Such a community can be set up to provide voice or video over IP services to members and non-members.

In another embodiment, a member is one that owns a mobile phone device with both data and voice services through a carrier. A community is formed by these members with a sponsoring corporation that sells or leases out the mobile phone devices. It is also possible that the sponsoring corporation does not sell or lease out any physical hardware devices, but rather it provides software to be inserted into the mobile phone devices. The community members share both the data and voice bandwidths and computing resources in the mobile phone devices. A partner is a business that provides third-party software that can be inserted into the mobile phone devices. Again, such a community can be set up to provide voice or video over IP services, interactive gaming, and location-based services (if a significant portion of the mobile phone devices are equipped with a location detecting device) to members and non-members.

In yet another embodiment, a member is an online retailer of a certain class of merchandize or service. A community is formed by these members with a sponsoring corporation that provides an Internet-based infrastructure to enhance these online retailers. The community members share information of supplies and demands so that as a group the community provides competitive pricing and large selections of goods and services. A partner is a vendor that provides third-party systems that can be used to enhance the services provided by the sponsoring corporation or a member retailer. A good behavior in this embodiment can be a consistently high quality of the goods and services provided by a retailer; a bad behavior is a low or inconsistent quality in goods and services provided by a retailer or a partner.

In yet another embodiment, a member is an IT (information technology) infrastructure owner. Thus a member can be a data center operator, or the IT department of a small or medium-sized enterprise. A community is formed by these members with a sponsoring corporation that provides a cloud-computing service for member and non-members. The community members share IT infrastructures individually owned by the members. A partner is a third-party vendor that sells systems that can be used to enhance the services provided by the sponsoring corporation and individual members. A good behavior in this embodiment can be a high or consistent quality in the IT services provided by a member or a partner; a bad behavior is a low or inconsistent quality in IT services provided by a member or a partner.

What is claimed is:

1. A method to enact bilateral feedbacks and commodity routing in a social-networking business, comprising:
a plurality of members, forming a social community;
a plurality of partners, each in a partnership with said community;
an optional sponsoring corporation that is a special privileged said partner that support said community with goods, services, or both;
wherein each said member shares or sells resources individually owned; each said partner provides goods, services, or both to said community; said sponsoring corporation or said community by itself aims to maximize the return on investment for the entirety of said community by enacting bilateral behavior-based feedbacks and behavior-based commodity routing.

2. The method of claim 1, wherein a said resource includes any of the following: (1) communication bandwidths, (2) computing resources such as CPU cycles, storage capacity, software license, memory space, etc., (3) goods and merchandize of all kinds, (4) services of all kinds, and (5) any combinations thereof.

3. The method of claim 2, wherein a good behavior includes one of the following by a said member or a said partner:
(1) Consistently providing high-quality resources to and for said community either for free or for fees;
(2) Providing content to and for said community either for free or for fees;
(3) Putting a network routing device in front of a NAT box between the public Internet and a private IP network for said community.

4. The method of claim 3, wherein a good behavior includes one of the following by a said member or a said partner:
(1) Violating the privacy of members and non-members of said community by eavesdropping on conversations carried out by said members or said partners;
(2) Malicious attacks on the infrastructure of said community or individual said members;
(3) Violating an intellectual property policy of said community;
(4) Inconsistently providing resources to or for said community.

5. The method of claim 4, a plurality of behavior measures is used to keep track of the historic, time-dependent, and current behaviors of each said member and said partner; rankings according to said measures are used as a basis to reward or to penalize individual said members and said partners in goods and services offered to said community.

6. The method of claim 5, wherein for each said member or partner, each good behavior induces an increase in credits in the behavior account of said member or said partner; each bad behavior induces an increase in the debits in the behavior account of said member or said partner.

7. The method of claim 2, wherein a policy of intellectual property rights is enacted that includes the following rules:
(1) To the extent an intellectual property utilizes said community infrastructure (which counts all hardware, software, and human efforts shared by said community members), said community has a proportional right to use it for free;
(2) All intellectual properties thus created belong to said community in part or in whole;
(3) All intellectual properties thus created belong to the individual creators in part or in whole;
(4) Said community owns distribution rights of the content thus created in part or in whole.

8. The method of claim 6, matching of goods and services from supply to demand sites are carried out in accordance with rules that include the following:
(1) The higher the behavioral credit ratings of demanding parties, the higher will be the quality of supplies routed to the demanding parties;
(2) While everything else being equal, for a given demand, multiple independent supply sources are to be used;
(3) While everything else being equal, for the same behavioral credit ratings, said members and said partners should be given an equal opportunity to be used as supply sources;
(4) While everything else being equal, said members and said partners with zero or low behavioral credit ratings should be given sufficient chances to function as supply sources, to enable their ratings to be improved.

9. The method of claim 8 wherein paths from sources to destinations in said community to route commodities (goods or service) are selected based a combination of the following metrics:
(1) The merit of a path is the sum of net behavioral credits minus debits of the nodes in the path;
(2) The merit of a path is the maximum of the net behavioral credits minus debits of the nodes in the paths;
(3) The merit of a path is a non-decreasing function of the net behavioral credits minus debits of the nodes in the paths.

10. A computer-readable medium with a computer program for performing the method as described in any one of claims 1 to 9.
